(19) United States
(12) Patent Application Publication
(10) Pub. No.: US 2006/0286342 A1
(43) Pub. Date: Dec. 21, 2006

(54) Re-entrant cellular multifunctional structure for energy absorption and method of manufacturing and using the same

(76) Inventor: Dana M. Elzey, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 10/557,560

(22) PCT Filed: May 27, 2004
(86) PCT No.: PCT/US04/16661

§ 371 Date: Nov. 21, 2005

Related U.S. Application Data
(60) Provisional application No. 60/473,694, filed on May 28, 2003.

(51) Int. Cl. B32B 3/10

(52) U.S. Cl. 428/131; 428/316.6; 428/174

(57) ABSTRACT

A cellular composite laminate structure (101) adapted for efficient energy absorption is provided along with the related use and method of manufacture. The structure uses rigid cellular core layers (102, 103) designed to remain rigid during impact loading to channel an imposed compressive force into plastic deformation of deforming sacrificial layers (116). The rigid cellular core layers (102, 103) are arranged such that they will interpenetrate during impact loading while the deforming sacrificial layers (116) are arranged such that they will impede interpenetration of the rigid cellular core layers (102, 103) and be subjected to tensile deformation only. The rigid cellular core layers (102, 103) and deforming sacrificial layers (116) can be formed to create two-dimensional cellular sheet or three-dimensional cellular topology structures. The deforming sacrificial layers (116) can be connected at various points to the rigid cellular core layers (102, 103) or can be connected only at the periphery of the overall structure. Higher strength, rigid materials are contemplated for the rigid cellular core layers (102, 103) while ductile materials are contemplated for the deforming sacrificial layers (116).

### RELATED APPLICATIONS

This application claims priority under 35 U.S.C. Section 119(e) of the earlier filing date of U.S. Provisional Application Ser. No. 60/473,694, filed on May 28, 2003, entitled “Re-entrant Cellular Composite for Energy Absorption and Method of Manufacturing and Using the Same,” the entire disclosure of which is hereby incorporated by reference herein.

### US GOVERNMENT RIGHTS

This invention was made with United States Government support under Grant No. 116941-101-GG10464-31340, awarded by the Office of Naval Research. The United States Government has certain rights in the invention.

### FIELD OF THE INVENTION

The present invention generally relates to cellular structures adapted for energy absorption, and more particularly a cellular multifunctional laminate structure that channels an imposing compressive force into plastic deformation of sacrificial layers of ductile material within the structure.

### BACKGROUND OF THE INVENTION

The ability of materials and structures to absorb the energy of impact or blast is an important performance attribute of a wide variety of engineering devices and systems, including such notable examples as automobiles, military vehicles, marine and aero-vehicles, highway guard rails, and embassies and other government buildings. Materials and structures for these applications are explicitly designed to exploit various mechanisms for absorbing and dissipating the kinetic energy associated with inertia or shock waves. Among these, the ability of metallic structures to deform plastically makes them particularly attractive. The plastic deformation of metallic materials occurs by an atomistic-level internal friction mechanism, which acts to convert most of the mechanical work done on the material into heat.

Energy absorption of metallic structures is optimized by selection of alloys which offer sufficient strength yet are ductile, withstanding large plastic strains prior to fracture. Further, metallic structures for energy absorption are frequently designed to crush, creating a sequence of folds, thereby increasing the volume of material participating in the deformation. Metal tubes or box beams subjected to axial compressive forces are good examples of such structures. Nonetheless, plastic deformation in such structures is typically localized in regions where bending occurs. Thus, even during crushing, a significant volume fraction of the metallic structure may remain relatively un-deformed.

Recent research has revealed that cellular metallic structures offer the potential to dramatically improve the amount of impact or blast energy which can be absorbed on a per-unit-mass basis. These low density, metallic structures may be either stochastic (as in the case of foamed metals) or periodic, such as those based on tetrahedral or pyramidal truss elements. Cellular metals, when used as cores in face sheet stiffened sandwich panels, are more structurally efficient than solid plates or sheet. However, cellular materials, in order to be accepted as superior alternatives to conventional (solid) materials, must also be competitively priced. Therefore research has also been directed at the identification and development of low cost manufacturing approaches. Among these are woven (textile) wire structures which are stacked and then bonded, either adhesively or metallurgically (e.g., by transient liquid phase sintering), and open cell truss structures created by perforating and forming sheet metal, stacking and bonding.

The high specific energy absorption capacity of cellular metal structures derives from their high density of truss elements (compressive struts) which distribute plastic deformation associated with bending more uniformly throughout the volume of the material during crushing. The cellular structure thus leads to a higher volume fraction of material participating in the plastic deformation, and thus increased energy absorption and dissipation per unit mass. Though enhanced relative to conventional (solid) structures, the truss elements making up the cellular metal still fail by buckling, followed by localized bending, such that much of the truss remains relatively un-deformed.

There is therefore a need in the art for an effective cellular structure that can efficiently provide improved specific energy absorption.

### BRIEF SUMMARY OF THE INVENTION

Some exemplary embodiments of the present invention provides a cellular structure designed wherein rather than localized bending, the trusses deform in axial tension, whereby a much greater volume fraction of the material can be made to participate in the plastic deformation process. Some exemplary embodiments of the present invention address this, among other things, by channeling the imposed crushing forces into deformation of axially loaded tensile struts.

Accordingly, regarding some embodiments no (or minimal) buckling occurs within the cellular structure and localized deformation by bending is minimized. Some exemplary embodiments of the present invention cellular structure therefore provide an improved specific energy absorption.

Some exemplary embodiments of the present invention provide a design, use and method of manufacture for a cellular composite laminate structure, which offers an efficient means for impact energy absorption. The structure provides efficient energy absorption by channeling an imposed compressive deformation (as during crushing on impact) into plastic deformation of sacrificial layers of ductile material within the composite. A second set of structural layers remains un-deformed (rigid) during crushing, and serves to channel the imposed displacement into tensile elongation of the ductile components. These two types of structural layers are arranged in alternating sequence to form a laminate structure of an overall thickness appropriate to a given application.

Imposed displacements (as during crushing on impact loading) are accommodated within the cellular composite laminate structure by interpenetration of the rigid layers (leading to densification of the structure), which are designed to be reentrant (i.e., they stack efficiently in analogy with stacking chairs or drinking glasses). Energy is absorbed (and dissipated as heat) as the ductile layers, which are sandwiched between the rigid cellular layers and thereby impede their interpenetration, are made to deform plastically, thus dissipating energy as heat.

An aspect of an embodiment of the present invention includes a structure for efficient impact energy absorption. The structure comprising: a first cellular layer; a second cellular layer, wherein the first and the second cellular core layers adapted to: remain at least substantially rigid (or rigid) during impact loading, and interpenetrate during impact loading. The structure further comprising: at least one sacrificial layer disposed between the first cellular layer and second cellular layer, wherein the sacrificial layer is adapted to: deform during impact loading, and impede the interpenetration of the first cellular layer and second cellular layer during impact loading.

An aspect of an embodiment of the present invention includes a method of making a structure for efficient impact energy absorption. The method comprising: providing a first cellular layer a second cellular layer, wherein the first rigid cellular core layer and second rigid cellular core layer are each adapted to remain at least substantially rigid during impact loading. The method further comprises providing at least one sacrificial layer, wherein the sacrificial layer is adapted to deform during impact loading. The first cellular layer and second cellular layer are adapted to interpenetrate during impact loading. The sacrificial layer is adapted to impede interpenetration of the first cellular layer and second cellular layer during impact loading. The sacrificial layer may be adapted to provide plastic deformation prior to its own fracture due to the impact loading.

An aspect of an embodiment of the present invention includes a method of efficiently absorbing impact energy during impact loading on a structure. The method comprising: providing the structure comprising a first cellular layer, a second cellular layer, a sacrificial layer there between; interpenetrating the first cellular layer and second cellular layer with one another as the first cellular layer and a second cellular layer are subjected to the impact load; and impeding the interpenetration of the first cellular layer and second cellular layer with the sacrificial layer, wherein the sacrificial layer opposes the forces imposed by the interpenetration.

An aspect of an embodiment of the present invention includes a structure and related method of use and manufacture that may be utilized for the following: an architectural structure, a civil engineering field structure, a machine field structure, an automobile structure, a ship structure, a freight car structure, an aircraft structure, a space station structure, or a submarine, ship, or water craft structure.

An aspect of an embodiment of the present invention includes a cellular composite laminate structure adapted for efficient energy absorption is provided along with the related use and method of manufacture. The structure may use rigid cellular core layers designed to remain rigid during impact loading to channel an imposed compressive force into plastic deformation of deforming sacrificial layers. The rigid cellular core layers may be arranged such that they will interpenetrate during impact loading while the deforming sacrificial layers are arranged such that they will impede interpenetration of the rigid cellular core layers and be subjected to tensile deformation only. The rigid cellular core layers and deforming sacrificial layers may be formed to create two-dimensional cellular sheet or three-dimensional cellular topology structures. The deforming sacrificial layers may be connected at various points to the rigid cellular core layers or can be connected only at the periphery of the overall structure. Higher strength, rigid materials may be provided for the rigid cellular core layers while ductile materials are contemplated for the deforming sacrificial layers.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 schematically illustrates a cross-sectional view of a reentrant cellular composite multifunctional laminate structure. FIG. 1(A) depicts the reentrant cellular composite laminate structure in an initial state (or near initial state) and FIG. 1(B) depicts the reentrant cellular composite laminate structure in a collapsed state.

FIG. 2 schematically illustrates a reentrant cellular composite laminate multifunctional structure in which the rigid cellular layers include arrays of tetrahedral truss structures and the deforming sacrificial layers are perforated or apertured ductile sheet metal (or non-metal sheet). FIG. 2(A) shows the initial state of the cellular composite laminate structure. FIG. 2(C) illustrates an enlarged partial view of a portion of the cellular composite laminate structure as shown in FIG. 2(A), wherein the deforming sacrificial layer is aligned above the lower cellular layer. FIG. 2(B) shows the compressed or collapsed configuration in which the rigid cellular core layers (upper and lower) are now interpenetrating and the deforming sacrificial layer is deformed to near its limit of ductile plastic strain.

### DETAILED DESCRIPTION OF INVENTION

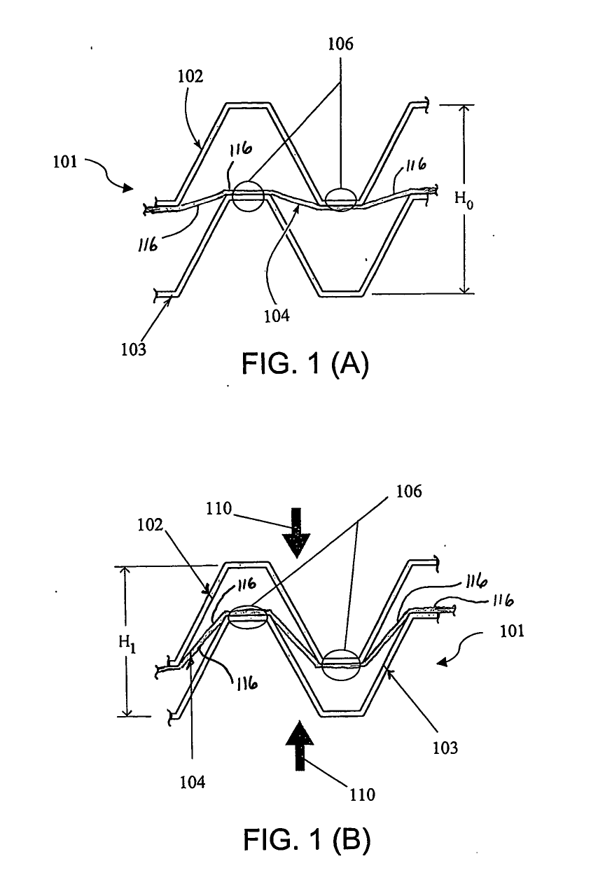

Referring generally to FIGS. 1(A)-(B), and as will be discussed in greater detail throughout this document, some exemplary embodiments of the present invention provides a multifunctional laminate structure 101 comprised of alternating layers of at least two types. The alternating layers having inter alia the various distinct characteristics. For example, characteristics of a first layer type may be lightweight, structurally efficient cellular design intended to interpenetrate when layers are compressed together as during deformation or impact loading. These layers are schematically represented by the upper cellular layer 102 and the lower cellular layer 103, and are arranged such that they are stacked directly on top of one another (e.g., in analogy with stacking chairs which interpenetrate to take up less space when stacked for storage). Referred to here as ‘cellular’ layers, they remain rigid (i.e., they do not deform) or at least substantially rigid during macroscopic compression of the laminate structure. Next, for example, characteristics of a second layer type, referred to as ‘sacrificial’ layers, may be initially flat (or substantially flat) or may also have a formed, cellular topology, and are composed of a ductile material suitable for absorption of energy by the mechanism of plastic deformation. These layers are schematically represented by the sacrificial layer 104. The sacrificial layer 104 may be constructed of a material (or composite) of at least one of metals, metal alloys, inorganic polymers, organic polymers, ceramics, glasses, semiconductors, electronic materials and photonic materials, and all composite derivatives, as well as any available material or combination of materials available to one skilled in the art.

The reentrant, cellular layers may be constructed using polymeric, metallic or ceramic materials or some combination of these, as well as any available material or combination of materials available to one skilled in the art. Typically, with regards to some embodiments, the upper cellular layer 102 and lower cellular layer 103 must possess adequate stiffness and strength such that they do not fail (by buckling or bending, plastic yielding, twisting, etc.) during compression of the laminate structure 101. The resulting laminate structure 101 shall be structurally efficient and cost-effective if, but not limited thereto, low density, readily available materials are used. In some embodiments, commercially available metal/alloy sheet is likely to provide the best combination of mechanical performance, cost and manufacturability for the cellular core constituent layers. The sheet metal (alloy or non-metal material) may be worked using existing manufacturing and processing approaches already developed for periodic cellular metals. Such cellular metals include, but are not limited to formed sheet (metal and/or non-metal) truss structures (e.g., tetrahedral, pyramidal, Kagome-like, and/or Kagome truss structures), woven (metal and/or non-metal) textiles, egg crate, etc. They may be manufactured by a combination of metal forming (bending, drawing, rolling, forging, etc.), cutting, machining and joining practices well known to the metal fabrication industry.

Still referring generally to FIGS. 1(A)-(B), and as will be discussed in greater detail throughout this document, some exemplary embodiments of present invention provide sacrificial layer(s) 104 which represent the only deforming component (or substantially deforming component) within the laminate structure 101 during compression, must be capable of efficiently dissipating the work (mechanical energy) needed to deform the laminate structure 101. The sacrificial layer 104 or layers are placed between interpenetrating cellular layers 102, 103 such that they are deformed when the laminate structure 101 is compressed. The cellular layers 102, 103 and sacrificial layers 104 are further designed such that the material within the sacrificial layers 104 will be subjected substantially to tensile loading and deformation only (as opposed to bending, torsion and/or compression). Although some bending may be unavoidable with certain embodiments or conditions, the deformation is predominantly uniform tension when designed in accordance with the invention. Once the laminate structure 101 has been compressed (e.g., crushed during blast or impact), the sacrificial layer(s) 104 may be removed and replaced by a new (un-deformed, undamaged) sacrificial layer(s) 104. The cellular layers 102, 103 may be hollow, solid or combination thereof.

The sacrificial layer(s) 104 may be a wire, strip, ribbon, band, sheet (continuous or perforated), or the like. The sacrificial layer 104 may be comprised of a plurality of segments or legs 116. Moreover, the segments or legs 116 (or any portion of the sacrificial layer 104) may be hollow, solid, or combination thereof.

The metallic or non-metallic materials as discussed throughout this document are provided possessing a combination of high yield strength (and/or work hardening rate) and ductility and therefore are exemplary candidates for the sacrificial layers 104. These attributes correlate with high specific energy absorption for materials which absorb energy by plastic deformation (i.e., by atomistic-level internal friction mechanisms, such as dislocation glide/climb processes). The material of the sacrificial layer 104 may also be lightweight and low cost. Perforated or apertured metal (and/or non-metal) sheet, produced by laser cutting, punching, water jet, electro-discharge machining, etc., may be used to create cellular sheet structures for these layers; or any other available production methods available to one skilled in the art.

The sacrificial layers may also be formed to create a cellular topology, i.e., to provide interlocking layer construction, to improve laminate structure shear strength, or to enhance specific energy absorption. Interlocking layer connections may be made by mechanical fastening (e.g., threaded fasteners, pins, clips, rivets, etc.), by metallurgical joining (e.g., welding, brazing, liquid phase sintering, UV welding bonded, electron beam welded, resistance welded, ultrasonically/friction welded, fusion welded, diffusion welding, spot welding, laser welding, etc.), or adhesive bond; or any other available interlocking devices and methods available to one skilled in the art.

While illustrations depict a flat or slightly bent/deformed sacrificial layer it should be appreciated that the sacrificial layers may be a variety of two-dimensional and three-dimensional structures, including for example, pyramidal, tetrahedral, kagome, or kagome-like truss structures.

Further it should be appreciated that a plurality of sacrificial layers may be stacked upon one another. Such sacrificial layers may also be similar or dissimilar from one another. Additionally, the cellular layers as discussed throughout may be repeated any number of times desired or required sufficient for any applicable uses discussed throughout this document or as needed for intended use or application.

Similarly, the composite laminate structures 101, 201, as discussed throughout, may be repeated any number of times desired or required sufficient for any applicable uses discussed throughout this document or as needed for intended use or application.

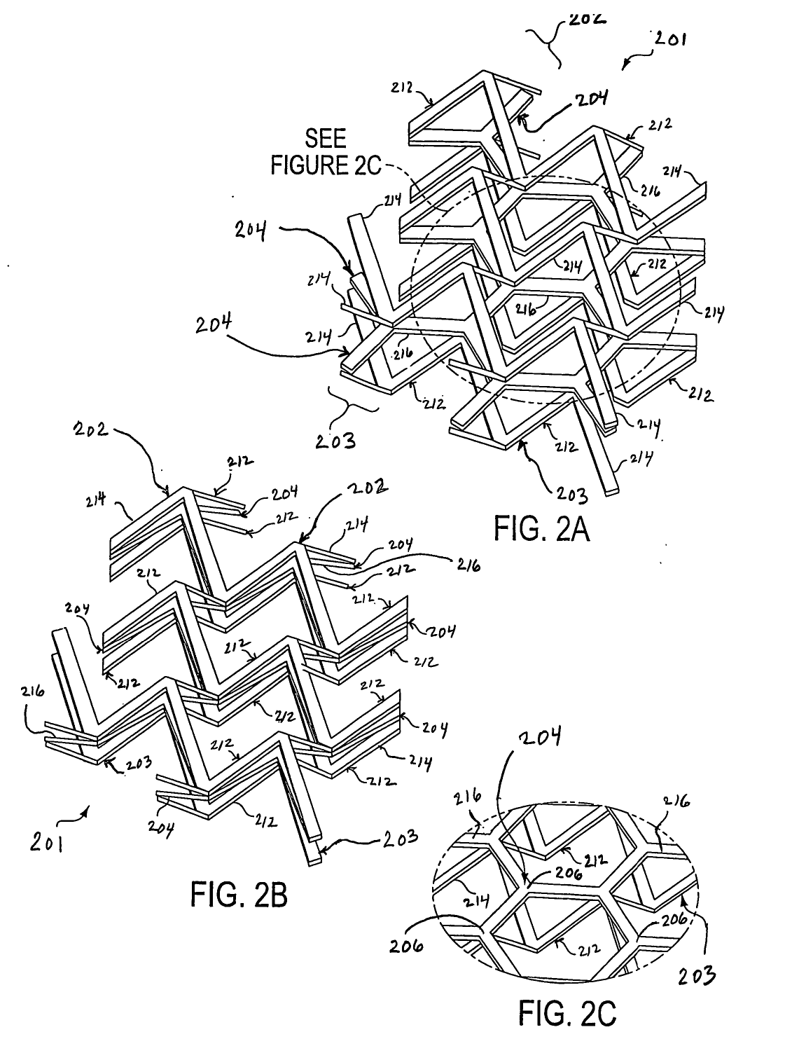

Though in some exemplary embodiments normally different materials would be selected for the construction of the two layer types (i.e., sacrificial layer(s) and upper/lower cellular layers), they may be made of the same material which, by virtue of differences in processing or shape, result in layers of high strength/stiffness alternating with layers of lower strength which deform sacrificially when the laminate is compressed. For example, referring briefly and generally to FIGS. 2(A)-(C), and as will be discussed in greater detail throughout this document, some exemplary embodiments of the cellular core layers may be formed such that truss ligaments or legs 214 of the truss units 212 have an angle or channel shape cross section, while portions or segments 216 within the sacrificial layers 204 have a cross section that is flat. Moreover, the segments or legs 216 (or any portion of sacrificial layer) may be hollow, solid, or combination thereof. Similarly, the truss ligaments or legs 214 (or any portion of the upper or lower cellular layer) may be hollow, solid, or combination thereof.

It should be appreciated that the cross sections of the truss legs, segments or portions of the upper cellular layer, lower cellular layer, and sacrificial layer may be formed of a variety of cross sections, including but not limited thereto, square, rectangular triangular, circular, tubular, or other cross sectional shape available to one skilled in the art. Moreover, the truss legs, segments or portions of the upper cellular layer, lower cellular layer, and sacrificial layer may be have a variety of shapes such as straight or curved.

Alternatively, with regards to FIGS. 1 and 2, as well as other related embodiments and design criteria discussed throughout the cellular core layers, such as 102, 103 or 202, 203, may be comprised of alloy which has been heat treated after forming to enhance strength, while the same material within the sacrificial layers, such as 104 or 204, is not heat treated, and therefore deforms at much lower stress.

Compared to a design for which the deforming sacrificial layer is initially flat, a corrugated design offers higher initial resistance to imposed deformation (i.e., the laminate structure exhibits greater compressive strength). Also, by having an initially nested arrangement of the rigid cellular core layers and deforming sacrificial layer, the overall shear strength and stiffness of the cellular composite laminate structure may be enhanced relative to the design with flat deforming sacrificial layers.

Referring to FIGS. 1(A)-(B), FIGS. 1(A)-(B) schematically illustrates a cross-sectional view of a reentrant cellular composite laminate structure 101. FIG. 1(A) schematically depicts the reentrant cellular composite laminate structure 101 in an initial (or near initial) state and FIG. 1(B) schematically depicts the reentrant cellular composite laminate structure 101 in a collapsed state, after the application of an external applied force 110. The upper cellular core layer 102, lower rigid cellular core layer 103, and deforming sacrificial layer 104 may each comprise a cellular sheet structure.

The sacrificial layer may be a perforated, porous, mesh, or an aperture sheet for example, or a combination thereof. The sacrificial layer as well as the upper and lower cellular layers may comprise an array of intersecting structural elements. Similarly, the sacrificial layer may comprise a multiple array of intersecting structural elements that are stacked, woven, or coupled upon one another. Moreover, for example, the pores or apertures of the sacrificial layers may include circular, square, rectangular, parallelogram, hexagonal triangular, ellipsoidal, pentagonal, octagonal, or combinations thereof or other desired shape. The sacrificial layers as well as the upper and lower cellular layers may be an array of first intersecting structural elements stacked on a second array of intersecting structural elements as shown in PCT International Application No. PCT/US03/PCT/US03/16844, entitled “Method for Manufacture of Periodic Cellular Structure and Resulting Periodic Cellular Structure,” filed on May 29, 2003, and corresponding U.S. application Ser. No. 10/296,728, filed Nov. 15, 2002, of which are hereby incorporated by reference herein in their entirety and assigned to the present assignee. The first and second intersecting structural elements may be an array of wires, ligaments, or tubes (of which may be solid or hollow). The sacrificial layer as well as the upper and lower cellular layers may be an array of braided or intersecting textile structural elements as shown for example PCT International Application No. PCT/US01/17363, entitled “Multifunctional Periodic Cellular Solids And The Method Of Making Thereof,” filed on May 29, 2001, and corresponding U.S. application Ser. No. 10/296,728, filed Nov. 25, 2002, of which are hereby incorporated by reference herein in their entirety and assigned to the present assignee).

The deforming sacrificial layer 104 can be connected to or in communication with the upper rigid cellular core layer 102 and/or lower rigid cellular core layer 103 at any possible point or points of contact 106 (e.g., region or regions) in order to, among other things, increase resistance to imposed deformation. Alternatively, the deforming sacrificial layer 104 can be connected to or in communication with the upper rigid cellular core layer 102 and/or lower cellular layer 103 only at the periphery of the reentrant cellular composite laminate structure 101. Further, the sacrificial layer 104 can be connected to or in communication with the upper cellular core layer 102 and/or lower cellular core layer 103 at any variety of contact points (or regions) as desired for a given application.

In some embodiments, the sacrificial layer may be connected to the cellular layers using a variety of methods including, but not limited thereto a pin, rotation, pivot joints/attachments or suitable means to accommodate relative rotation of components during crushing.

It should also be appreciated that mechanical communication at contact regions or points does not necessarily mean direct contact, but may permit, for example, bond-aiding interlayers or other interlayers as desired.

It should be appreciated that any truss units discussed throughout this document, applicable to the upper and lower cellular layers as well as the sacrificial layer(s) may be comprised of: legs or ligaments; closed cell analogs (solid or semi-solid faces); or any combination thereof.

Referring to FIGS. 1(A)-(B), the reentrant cellular composite laminate structure 101 has an initial height, H₀, as measured from the upper cellular layer 102 to lower rigid cellular core layer 103. An applied force 110 pushes the upper cellular layer 102 and lower cellular layer 103 together or at least generally toward one another. The upper cellular layer 102 and lower cellular layer 103 are designed to be aligned in a stackable or reentrant arrangement of any varying degree. Further, the upper cellular layer 102 and lower cellular layer 103 are designed to remain rigid or at least substantially rigid during impact loading. Thus, application of an external applied force 110 onto reentrant cellular composite laminate structure 101 causes the upper cellular layer 102 and lower cellular layer 103 to interpenetrate (i.e., partially or entirely). As the upper cellular layer 102 and lower cellular layer 103 interpenetrate, the applied force 110 is channeled to the deforming sacrificial layer 104 which impedes the interpenetration of the upper cellular layer 102 and lower cellular layer 103. In turn, the sacrificial layer 104 plastically deforms. The result is a compressed reentrant cellular composite laminate structure 101 of height H₁. It should be appreciated that various intermediate height levels are possible depending on structural design, magnitude of applied force(s), and repetition of such applied force. The interpenetration may occur after successive impacts or loads.

The arrangement of reentrant rigid cellular core layers and deforming sacrificial layers is readily extendable to the formation of periodic cellular structures as shown by the exemplary embodiment depicted in FIGS. 2(A)-(C). FIG. 2(A) schematically illustrates reentrant cellular composite laminate structure 201 before impact loading. FIG. 2(C) schematically illustrates an enlarged partial view of a portion of reentrant cellular composite laminate structure 201 depicted in FIG. 2(A), but with the upper cellular layer 202 omitted for the purpose of simplifying the illustration. FIG. 2(B) schematically illustrates reentrant cellular composite laminate structure 201 after impact loading. In referring to FIG. 2(A), the upper cellular layer 202 and lower cellular layer 203 are aligned with a deforming sacrificial layer 204. In this embodiment, upper cellular layer 202 and lower cellular layer 203 are comprised of an array of truss units 212 having the design of tetrahedral trusses. The deforming sacrificial layer 204 has the design of a perforated hexagonal sheet or layer. The sacrificial layer 204 may be comprised of a plurality of segments or legs 216. Moreover, the segments or legs 216 (or any portion of the sacrificial layer 204) may be hollow, solid, or combination thereof. It should be appreciated that various cellular core topologies may be implemented according to the design criteria discussed throughout this document. Referring to FIG. 2(C), reference number 206 reveals the location where a node or leg 214 of upper cellular layer 202 (not shown in FIG. 2(C)) would connect to or be in communication with the deforming sacrificial layer 204. FIG. 2(B) reveals the arrangement of upper rigid cellular core layer 202 and lower rigid cellular core layer 203 as interpenetrating tetrahedra with deforming sacrificial layer 204 impeding further interpenetration.

It should be appreciated that the upper cellular layer 102, 202 and lower cellular layer 103, 203 (or any additional upper or lower cellular layers provided in addition thereto) as discussed throughout this document can be planar, substantially planar, and/or curved shape, with various contours as desired and required. Similarly, it should be appreciated that the sacrificial layer 104, 204 (or any additional sacrificial layers provided in addition thereto) as discussed throughout this document can be planar, substantially planar, and/or curved shape, with various contours as desired and required. As such the respective multifunctional laminate structure 101, 201 may be shaped, formed, designed and bent accordingly.

Further, although not shown, face members or panels may be included on the upper and lower cellular layers. Moreover, face members or panels may be included on the side of the laminate structure (spanning for example from the upper to the lower cellular layer) or the face members or panels may also be at various angles. Moreover, the face members or panels may be disposed at the interior of the laminate structure between the various layers at the desired or required location. It should be appreciated that any number of upper and lower cellular layers, sacrificial layers, panels (interior and exterior) may be stacked upon one another, as well as in between one another. The face member or panel may comprise at least one of a panel, perforated structure, porous structure, mesh structure, aperture sheet, or array of intersecting members structure, or any combination thereof. For example, See International Application No. PCT/US03/27606, filed Sep. 3, 2003, entitled “Method for Manufacture of Truss Core Sandwich Structures and Related Method Thereof” (of which is hereby incorporated by reference herein in its entirety and is assigned to the present assignee).

Various embodiments of the present invention laminate structure can serve as multifunctional structures. The multifunctional features of the present invention laminate structure (with or without sandwich panels) may address a variety of functions. For example, it may address specific problems in the arenas of ballistic projectile/fragment capture. The laminate structure offers a high stiffness to weight and high energy absorption to weight ratio for civil, aerospace and military structures. The laminate structure can be further augmented, for a minimal weight increase, to contain errant or intended ballistic projectiles (bullets, turbine blade fragments, shrapnel, flying debris, etc.). This may be achieved by the addition of intermediate members, such as polymeric fabric strips on the interior faces of the metal facesheets. These fabrics act as nets to snare incoming flying objects. Additionally, the interstitial elements, such as hard engineered ceramics (i.e., aluminum oxide, silicon carbide, boron carbide, or titanium diboride) can be added to the truss core open spaces in the form of prisms or powder infusions. For example, See PCT International Application No. PCT/US03/27605, entitled “Blast and Ballistic Protection Systems and Methods of Making the Same,” filed on Sep. 3, 2003 (of which is hereby incorporated by reference herein in its entirety and is assigned to the present assignee). See PCT/US03/23043, entitled “Method for Manufacture of Cellular Materials and Structures for Blast and Impact Mitigation and Resulting Structure,” filed on Jul. 23, 2003. (of which is hereby incorporated by reference herein in its entirety and is assigned to the present assignee).

According to the design criteria discussed throughout, SMA attributes and structures may be implemented with the present invention as described in the co-pending and commonly assigned PCT Application No.: PCT/US02/27116 filed Aug. 26, 2002, entitled “Reversible Shape Memory Multifunctional Structural Designs and Method of Using the Same,”, and corresponding U.S. application Ser. No. 10/487,291, filed Feb. 20, 2004, of which are hereby incorporated by reference herein in their entirety.

According to the design criteria discussed throughout, other two-dimensional and three-dimensional structures (including core, face members/panels, and other included components) and their related methods of use and manufacture may be implemented with the present invention as shown in co-pending and co-assigned PCT International Application No. PCT/US02/17942, entitled “Multifunctional Periodic Cellular Solids and The Method of Making hereof,” filed on Jun. 6, 2002, and corresponding U.S. application Ser. No. 10/479,833, filed Dec. 5, 2003, of which are hereby incorporated by reference herein in their entirety.

According to the design criteria discussed throughout, other two-dimensional and three-dimensional structures (including core, face members/panels, and other included components) and related methods of use and manufacture may be implemented with the present invention as provided in co-pending and co-assigned PCT International Application No. PCT/US01/17363, entitled “Multifunctional Periodic Cellular Solids And The Method Of Making Thereof,” filed on May 29, 2001, and corresponding U.S. application Ser. No. 10/296,728, filed Nov. 25, 2002, of which are hereby incorporated by reference herein in their entirety.

According to the design criteria discussed throughout, other two-dimensional and three-dimensional structures (including core, face members/panels, and other included components) and related methods of use and manufacture may be implemented with the present invention as shown in co-pending and commonly assigned PCT International Application No. PCT/US03/16844, entitled “Method for Manufacture of Periodic Cellular Structure and Resulting Periodic Cellular Structure,” filed on May 29, 2003, of which is hereby incorporated by reference herein in its entirety.

According to the design criteria discussed throughout, other two-dimensional and three-dimensional structures (including core, face members/panels, and other included components) and related methods of use and manufacture may be implemented with the present invention as shown in co-pending and commonly assigned PCT International Application No. PCT/US04/04608, entitled “Methods for Manufacture of Multilayered Multifunctional Truss Structures and Related Structures there from,” filed on Feb. 17, 2004, of which is hereby incorporated by reference herein in its entirety.

According to the design criteria discussed throughout, other two-dimensional and three-dimensional structures may be implemented with the present invention as provided in co-pending and co-assigned PCT International Application No. PCT/US03/17049, entitled “Active Energy Absorbing Cellular Metals and Method of Manufacturing and Using the Same,” filed on May 30, 2003, of which is hereby incorporated by reference herein in its entirety.

In addition to the high mechanical performance of multifunctional laminate structures (in whole or part); they lend themselves to multifunctional concepts. Such multifunctional concepts include heat transfer according to the design criteria and function as shown in PCT International Application No. PCT/US01/22266, entitled “Heat Exchange Foam,” filed on Jul. 16, 2001, and corresponding U.S. application Ser. No. 10/333,004, filed Jan. 14, 2003 (of which are hereby incorporated by reference herein in their entirety and are assigned to the present assignee).

Another multifunctional concept includes battery or power storage cores, for example, according to the design criteria and concept as shown in PCT International Application No. PCT/US01/25158, entitled “Multifunctional Battery and Method of Making the Same,” filed on Aug. 10, 2001, and corresponding U.S. application Ser. No. 10/110,368, filed Jul. 22, 2002 (of which are hereby incorporated by reference herein in their entirety and are assigned to the present assignee).

There are numerous other functionalities, which can be added into or with the various embodiments of the present invention laminate structures making them ideal candidates for “structure plus” multifunctional materials/structures. For example the general present invention laminate structure and structural material (as well their related methods of manufacture and use) may be involved in and applied to architectural structures (for example: pillars, walls, shielding, foundations or floors for tall buildings or pillars, wall shielding floors, for regular buildings and houses), the civil engineering field (for example; road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, airport structures such as runways) and the machine structure field (frame structures for carrying system, carrying pallets, frame structure for robots, etc.), the automobile (the body, frame, doors, chassis, roof and floor, side beams, bumpers, etc.), the ship (main frame of the ship, body, deck, partition wall, wall, etc.), freight car (body, flame, floor, wall, etc.), aircraft (wing, main frame, body, floor, etc.), spacecraft (body, flame, floor, wall, etc.), the space station (the main body, floor, wall, etc.), the submarine, ship, water craft (the body, frame, etc.), and is related to the structural material which requires extreme dynamic strength.

Accordingly, various embodiments of the present invention laminate structures (as well as their related methods of manufacture and use) may be applied to a variety of applications including, but not limited thereto: crash/impact energy absorption systems for automobile interiors, packaging, crates, containers, weapons containers tossed/parachuted from aircraft/helicopters, architectural applications, interior/exterior panels/padding, aircraft interiors, and military vehicle interiors, etc. (as well as applications discussed throughout this document).

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, section, abstract, drawing figure, etc.) of this application, unless clearly specified to the contrary, there is no requirement for any particular described or illustrated activity or element, any particular sequence of such activities, any particular size, speed, dimension or frequency, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive.

We claim:

1. A structure for efficient impact energy absorption, the structure comprising:
a first cellular layer;
a second cellular layer, said first and said second cellular core layers adapted to:
remain at least substantially rigid during impact loading, and
interpenetrate during impact loading;
at least one sacrificial layer disposed between said first cellular layer and said second cellular layer, said sacrificial layer adapted to:
deform during impact loading, and
impede the interpenetration of said first cellular layer and said second cellular layer during impact loading.

2. The structure of claim 1, wherein said sacrificial layer deforms plastically.

3. The structure of claim 1, wherein said sacrificial layer is subjected to tensile loading during the impact loading.

4. The structure of claim 1, wherein said sacrificial layer comprises a periodic cellular structure.

5. The structure of claim 1, wherein said sacrificial layer comprises a perforated sheet.

6. The structure of claim 5, wherein said perforated sheet comprises of perforations having at least one of the shapes including circular, square, rectangular, parallelogram, hexagonal, triangular, ellipsoidal, pentagonal, octagonal, or combinations thereof.

7. The structure of claim 1, wherein said sacrificial layer comprises an aperture sheet.

8. The structure of claim 7, wherein said aperture sheet comprises of apertures having at least one of the shapes including circular, square, rectangular, parallelogram, hexagonal, triangular, ellipsoidal, pentagonal, octagonal, or combinations thereof.

9. The structure of claim 1, wherein said sacrificial layer is comprised of truss units.

10. The structure of claim 9, wherein said truss units are comprised of at least one shape or combination of the shapes including tetrahedral, pyramidal, or Kagome.

11. The structure of claim 1, wherein said sacrificial layer comprises a woven or braided structure.

12. The structure of claim 1, wherein said sacrificial layer comprises a cellular sheet structure.

13. The structure of claim 12, wherein said cellular sheet structure is at least substantially flat.

14. The structure of claim 1, wherein said sacrificial layer comprises at least one shape or combination of the shapes including corrugated or egg crate.

15. The structure of claim 1, wherein said sacrificial layer that is at least one of curved, planar, substantially planar, or has a plurality of curves.

16. The structure of claim 1, wherein said sacrificial layer is comprised of a material of at least one of metals, metal alloys, inorganic polymers, organic polymers, ceramics, glasses, semiconductors, electronic materials and photonic materials, and all composite derivatives.

17. The method of claim 1, wherein said sacrificial layer is comprised of a composite formed of a material of at least one of metals, metal alloys, inorganic polymers, organic polymers, ceramics, glasses, semiconductors, electronic materials and photonic materials.

18. The method of claim 1, wherein the topology of said sacrificial layer includes at least one of stamped sheet goods, woven textiles, expanded sheet goods, expanded metal, laser cut sheets, perforated sheets, wires, strips, bands, and hollow tube arrays or any combination thereof.

19. The structure of claim 1, wherein said sacrificial layer comprise a plurality of segments.

20. The structure of claim 19, wherein at least some of said plurality of segments have a cross section including at least one of square, rectangular triangular, circular, tubular, or combination thereof.

21. The structure of claim 1, wherein said first cellular layer and said second cellular layer each comprises a periodic cellular structure.

22. The structure of claim 21, wherein said periodic cellular structure comprises truss units.

23. The structure of claim 1, wherein said first cellular layer and said second cellular layer are comprised of truss units.

24. The structure of claim 23, wherein said truss units are comprised of truss legs.

25. The structure of claim 24, wherein said at least a plurality of said truss legs have a channel or angled shaped cross section.

26. The structure of claim 24, wherein at least plurality of said plurality truss legs have a cross section including at least one of square, rectangular triangular, circular, tubular, or combination thereof.

27. The structure of claim 23, wherein said truss units are comprised of at least one shape or combination of the shapes including tetrahedral, pyramidal, or Kagome.

28. The structure of claim 1, wherein said first cellular layer and said second cellular layer each comprises at least one shape or combination of the shapes including a corrugated shape structure or an egg crate structure.

29. The structure of claim 1, wherein at least one of said first cellular layer and said second cellular layer is comprised of a material of at least one of metals, metal alloys, inorganic polymers, organic polymers, ceramics, glasses, semiconductors, electronic materials and photonic materials, and all composite derivatives.

30. The method of claim 1, wherein at least one of said first cellular layer and said second cellular layer is comprised of a composite formed of a material of at least one of metals, metal alloys, inorganic polymers, organic polymers, ceramics, glasses, semiconductors, electronic materials and photonic materials.

31. The structure of claim 1, wherein said sacrificial layer is in communication with said first cellular layer and/or in communication with said second cellular layer at at least one point or region of contact.

32. The structure of claim 31, wherein said communication comprises at least one mechanical fastening device.

33. The structure of claim 32, wherein said mechanical fastening device comprises at least one of threaded fasteners, pins, clips, or rivets.

34. The structure of claim 31, wherein said communication comprises at least one metallurgical joint.

35. The structure of claim 34, wherein said joint comprises at least one of welding joint, brazing joint, liquid phase sintering joint, spot welding joint, or laser welding joint.

36. The structure of claim 31, wherein said communication comprises at least one adhesive bond.

37. The structure of claim 1, wherein said structure comprises at least one of:
an architectural structure,
a civil engineering field structure,
a machine field structure,
an automobile structure,
a ship structure,
a freight car structure,
an aircraft structure,
a space station structure, or
a submarine, ship, or water craft structure.

38. The structure of claim 37, wherein:
said architectural structure comprises at least one of
pillars, walls, shielding, foundations or floors for buildings or pillars, or wall shielding floors,
said civil engineering field structure comprises at least one of
road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, or airport structures such as runways,
said machine field structure comprises at least one of
frame structures for carrying system, carrying pallets, or frame structure for robots, etc.,
said automobile structure comprising at least one of
a body, frame, doors, chassis, roof and floor, side beams, or bumpers, etc.,
said ship structure comprising at least one of:
a main frame of the ship, body, deck, partition wall, or wall, etc.,
said freight car structure comprising at least one of
body, frame, floor, or wall, etc.,
said aircraft structure comprising at least one of
a wing, main frame, body, or floor, etc.,
said spacecraft comprising at least one of
a body, frame, floor, or wall, etc.,
said space station comprising at least one of
a main body, floor, or wall, etc., and
said submarine, ship, or water craft comprising at least one of
a body, or frame, etc.

39. A method of making a structure for efficient impact energy absorption, the method comprising:
providing a first cellular layer;
providing a second cellular layer, said first rigid cellular core layer and said second rigid cellular core layer each adapted to remain at least substantially rigid during impact loading;
providing at least one sacrificial layer, said sacrificial layer adapted to deform during impact loading;
said first cellular layer and said second cellular layer adapted to interpenetrate during impact loading; and
said sacrificial layer adapted to impede interpenetration of said first cellular layer and said second cellular layer during impact loading.

40. The method of claim 39, wherein said sacrificial layer is adapted to provide plastic deformation prior to its own fracture due to the impact loading.

41. The method of claim 39, wherein said first cellular layer and said second cellular layers are made from a material selected from the group consisting of polymers, metals, and ceramics.

42. The method of claim 39, wherein said first cellular layer and said second cellular layers are made from composites selected from the group consisting of polymers, metals, and ceramics.

43. The method of claim 39, wherein said sacrificial layer is made from at least one material having a combination of high yield strength and ductility.

44. The method of claim 39, wherein said sacrificial layer is made from the same material as at least one of said first cellular layer and said second cellular layer.

45. The method of claim 39, wherein said structure comprises at least one of:
an architectural structure,
a civil engineering field structure,
a machine field structure,
an automobile structure,
a ship structure,
a freight car structure;
an aircraft structure,
a space station structure, or
a submarine, ship, or water craft structure.

46. The method of claim 45, wherein:
said architectural structure comprises at least one of
pillars, walls, shielding, foundations or floors for buildings or pillars, or wall shielding floors,
said civil engineering field structure comprises at least one of
road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, or airport structures such as runways,
said machine field structure comprises at least one of
frame structures for carrying system, carrying pallets, or frame structure for robots, etc.,
said automobile structure comprising at least one of
a body, frame, doors, chassis, roof and floor, side beams, or bumpers, etc.,
said ship structure comprising at least one of:
a main frame of the ship, body, deck, partition wall, or wall, etc.,
said freight car structure comprising at least one of
body, frame, floor, or wall, etc.,
said aircraft structure comprising at least one of
a wing, main frame, body, or floor, etc.,
said spacecraft comprising at least one of
a body, frame, floor, or wall, etc.,
said space station comprising at least one of
a main body, floor, or wall, etc., and
said submarine, ship, or water craft comprising at least one of
a body, or frame, etc.

47. A method of efficiently absorbing impact energy during impact loading on a structure, the method comprising:
providing the structure comprising a first cellular layer, a second cellular layer, and a sacrificial layer there between;
interpenetrating said first cellular layer and said second cellular layer with one another as said first cellular layer and a second cellular layer are subjected to the impact load; and
impeding the interpenetration of said first cellular layer and a second cellular layer with the sacrificial layer, wherein said sacrificial layer opposes the forces imposed by the interpenetration

48. The method of claim 47, wherein said structure comprises at least one of:
an architectural structure,
a civil engineering field structure,
a machine field structure,
an automobile structure,
a ship structure,
a freight car structure,
an aircraft structure,
a space station structure, or
a submarine, ship, or water craft structure.

49. The method of claim 48, wherein:
said architectural structure comprises at least one of
pillars, walls, shielding, foundations or floors for buildings or pillars, or wall shielding floors,
said civil engineering field structure comprises at least one of
road facilities such as noise resistant walls and crash barriers, road paving materials, permanent and portable aircraft landing runways, pipes, segment materials for tunnels, segment materials for underwater tunnels, tube structural materials, main beams of bridges, bridge floors, girders, cross beams of bridges, girder walls, piers, bridge substructures, towers, dikes and dams, guide ways, railroads, ocean structures such as breakwaters and wharf protection for harbor facilities, floating piers/oil excavation or production platforms, or airport structures such as runways,
said machine field structure comprises at least one of
frame structures for carrying system, carrying pallets, or frame structure for robots, etc.,
said automobile structure comprising at least one of
a body, frame, doors, chassis, roof and floor, side beams, or bumpers, etc.,
said ship structure comprising at least one of:
a main frame of the ship, body, deck, partition wall, or wall, etc.,
said freight car structure comprising at least one of
body, frame, floor, or wall, etc.,
said aircraft structure comprising at least one of
a wing, main frame, body, or floor, etc.,
said spacecraft comprising at least one of
a body, frame, floor, or wall, etc.,
said space station comprising at least one of
a main body, floor, or wall, etc., and
said submarine, ship, or water craft comprising at least one of
a body, or frame, etc.
